(19) United States
(12) Patent Application Publication
(10) Pub. No.: US 2010/0017922 A1
(43) Pub. Date: Jan. 21, 2010

(54) INTEGRATED SENSING PROBES, METHODS OF FABRICATION THEREOF, AND METHODS OF USE THEREOF

(76) Inventors: Heungjoo Shin, Ulsan (KR); Boris Mizaikoff, Atlanta, GA (US); Dustin Polke, Siegen (DE)

Correspondence Address: THOMAS, KAYDEN, HORSTEMEYER & RISLEY, LLP, 600 GALLERIA PARKWAY, S.E., STE 1500, ATLANTA, GA, 30339-5994, US

(21) Appl. No.: 12/302,202

(22) PCT Filed: May 31, 2007
(86) PCT No.: PCT/US07/70092

§ 371 Date: Jun. 29, 2009

Related U.S. Application Data
(60) Provisional application No. 60/809,593, filed on May 31, 2006.

(51) Int. Cl. G01N 13/10; G02B 6/00; G01N 21/00

(52) U.S. Cl. 850/21; 385/12

(57) ABSTRACT

Briefly described, embodiments of this disclosure include integrated sensing probes, sensing systems, methods of detecting a target compound, and the like. One exemplary integrated sensing probe, among others, includes: a substrate, a circular corrugated reflective surface, and a coaxial waveguide structure, wherein the corrugated reflective surface and the coaxial waveguide structure are disposed on the substrate, wherein the coaxial waveguide structure is positioned at the center of the circular corrugated reflective surface.

### CROSS-REFERENCE TO RELATED APPLICATION

This application is related to copending U.S. Provisional Application entitled “Integrated terahertz nearfield imaging probe” Ser. No. 60/809,593, filed on May 31, 2006, which is entirely incorporated herein by reference.

### BACKGROUND

Ever since the development of the microscope, researchers have worked diligently on ways to increase the spatial resolution of imaging and/or sensing devices for analyzing or sensing objects with smaller dimensions, lower concentrations, and diminished total amounts. Usually, sensing or observing with any electromagnetic radiation of wavelength (λ) is restricted by standard diffraction theory to minimally resolvable features at approximately 0.61λ. A highly interesting alternative approach is the use of a small sub-wavelength aperture with a diameter (d) to confine electromagnetic radiation in the vicinity of the probed object to sub-wavelength dimensions. This concept is readily applicable to the near-field of such a probe, as shown e.g., by the seminal work of D. W. Pohl et al (Appl. Phys. Lett. 44, 651, 1984). However, using a simple aperture leads to substantial loss in transmission of electromagnetic radiation. The transmissivity is proportional to the size of the aperture d, and inversely proportional to the wavelength λ, each to the power of 4 (approx. d⁴/l⁴), as shown by H. A. Bethe (Phys. Rev. 66, 163-82, 1944). This dependence leads to prohibitively high losses when using small apertures, and therefore severely limits the efficiency of aperture-based near-field concepts. However, substantial interest exists today for efficient and flexibly useable near-field electromagnetic probes that can be reproducibly fabricated, as numerous applications would significantly benefit from such a development.

### SUMMARY

Briefly described, embodiments of this disclosure include integrated sensing probes, sensing systems, methods of detecting a target compound, integrated sensing and scanning probe systems, and the like. One exemplary integrated sensing probe, among others, includes: a substrate, a circular corrugated reflective surface, and a coaxial waveguide structure, wherein the corrugated reflective surface and the coaxial waveguide structure are disposed on the substrate, wherein the coaxial waveguide structure is positioned at the center of the circular corrugated reflective surface.

An exemplary sensing system, among others, includes: an irradiation source; an integrated sensing probe disposed adjacent the irradiation source, wherein the integrated sensing probe includes a substrate, a circular corrugated reflective surface, and a coaxial waveguide structure, wherein the corrugated reflective surface and the coaxial waveguide structure are disposed on the substrate, wherein the coaxial waveguide structure is positioned at the center of the circular corrugated reflective surface; and a detection system adjacent the integrated sensing probe.

An exemplary method of detecting a target compound, among others, includes: providing a substrate having the target compound disposed thereon; placing an integrated sensing probe disposed adjacent the irradiation source, wherein the integrated sensing probe includes a substrate, a circular corrugated reflective surface, and a coaxial waveguide structure, wherein the corrugated reflective surface and the coaxial waveguide structure are disposed on the substrate, wherein the coaxial waveguide structure is positioned at the center of the circular corrugated reflective surface; irradiating a position on the substrate with radiation from the coaxial waveguide structure; and measuring a signal.

An exemplary integrated sensing and scanning probe system, among others, includes: an integrated sensing probe that includes a substrate, a corrugated reflective surface, and a coaxial waveguide structure, wherein the corrugated reflective surface and the coaxial waveguide structure are disposed on the substrate, wherein the coaxial waveguide structure is positioned at the center of the corrugated reflective surface.

Another exemplary integrated sensing probe, among others, includes: a substrate, a corrugated reflective surface, and a coaxial waveguide structure, wherein the corrugated reflective surface and the coaxial waveguide structure are disposed on the substrate, wherein the coaxial waveguide structure is positioned at the center of the corrugated reflective surface; wherein the corrugated reflective surface includes a plurality of ridges concentric around the coaxial waveguide structure, wherein each ridge has a center at the position of the coaxial waveguide structure, wherein the corrugated reflective surface includes a reflective layer disposed on an area from the coaxial waveguide structure to the outer most ridge of the corrugated reflective surface; and wherein the coaxial waveguide structure includes an efficient coupling structure, an inner core, a dielectric layer, and a coaxial waveguide tip, wherein the inner core is disposed on the efficient coupling structure, wherein the coaxial waveguide tip is disposed on the inner core, and wherein the dielectric layer is disposed on the sides of the inner core, wherein the coaxial waveguide tip includes a first portion of the inner core that is covered by the dielectric layer and the dielectric layer is covered by the reflective layer, wherein the coaxial waveguide tip includes a second portion of the inner core that is not covered by the dielectric layer and the dielectric layer is covered by the reflective layer, and wherein the reflective layer is not in direct contact with the inner core.

Other systems, methods, features, and advantages of this disclosure will be or become apparent to one with skill in the art upon examination of the following drawings and detailed description. It is intended that all such additional systems, methods, features, and advantages be included within this description, be within the scope of this disclosure, and be protected by the accompanying claims.

### BRIEF DESCRIPTION OF THE DRAWINGS

Further aspects of the present disclosure will be more readily appreciated upon review of the detailed description of its various embodiments, described below, when taken in conjunction with the accompanying drawings.

The patent or application file contains at least one drawing executed in color. Copies of this patent or patent application publication with color drawing(s) will be provided by the Office upon request and payment of the necessary fee.

FIGS. 1A and 1C illustrate cross-sectional views of an embodiment of an integrated sensing probe.

FIG. 1B illustrates a top view of the integrated sensing probe.

FIG. 2 illustrates an embodiment of a sensor system that includes an embodiment of an integrated sensing probe, a sample, and a detection system.

FIG. 3 illustrates an embodiment of a scanning integrated sensing probe that includes an integrated sensing probe and a micro-cantilever sample stage.

FIGS. 4A through 4K illustrate an embodiment of a method of fabricating and embodiment of the integrated sensing probe shown in FIG. 1.

FIG. 5 illustrates a simulation of the electric field near the corrugated reflective surface, of which the first corrugation disk radius is ¾λ.

FIG. 6 illustrates a simulation of the electric field at the coupling region (ratio of outer radius to inner radius of the coaxial waveguide structure=1.2).

FIGS. 7A through 7F show SEM images of fabrication steps of the coaxial waveguide tip. FIG. 7A illustrates a dry-etched silicon tip, FIG. 7B illustrates a sharpened tip using thermal oxidation sharpening, FIG. 7C illustrates the silicon core of a coaxial waveguide and tip covered with a SiO₂ dielectric layer, FIG. 7D illustrates a silicon guide base providing an efficient coupling layer, FIG. 7E illustrates a metal coated corrugated reflective surface, and FIG. 7F illustrates a sharp probe tip with a ring shaped coaxial aperture.

FIG. 8A through 8D show sub-wavelength aperture and tip fabrication schemes using FIB milling and wet etching. FIG. 8A illustrates a silicon dioxide/gold coated silicon tip, FIG. 8B illustrates a first FIB milling, FIG. 8C illustrates a second FIB milling after 90° rotation along the axis of the tip, and FIG. 8D illustrates an exposed silicon tip after silicon dioxide wet etching.

### DETAILED DESCRIPTION

Embodiments of the present disclosure will employ, unless otherwise indicated, techniques of physics, chemistry, biochemistry, biology, and the like, which are within the skill of the art. Such techniques are explained fully in the literature and will not be detailed herein.

The following examples are put forth so as to provide those of ordinary skill in the art with a complete disclosure and description of how to perform the methods and use the compositions and compounds disclosed and claimed herein. Efforts have been made to ensure accuracy with respect to numbers (e.g., amounts, temperature, etc.), but some errors and deviations should be accounted for. Unless indicated otherwise, parts are parts by weight, temperature is in ° C., and pressure is at or near atmospheric. Standard temperature and pressure are defined as 20° C. and 1 atmosphere.

Before the embodiments of the present disclosure are described in detail, it is to be understood that, unless otherwise indicated, the present disclosure is not limited to particular materials, reagents, reaction materials, surface coatings, recognition chemistries with chemical, biochemical, biological, and/or synthetic/biomimetic receptors, manufacturing processes, dimensions, frequency ranges, applications, or the like, as such can vary. It is also to be understood that the terminology used herein is for purposes of describing particular embodiments only, and is not intended to be limiting. It is also possible in the present disclosure that steps can be executed in different sequence, where this is logically possible. It is also possible that the embodiments of the present disclosure can be applied to additional embodiments involving measurements beyond the examples described herein, which are not intended to be limiting. It is furthermore possible that the embodiments of the present disclosure can be combined or integrated with other measurement techniques beyond the examples described herein, which are not intended to be limiting.

It should be noted that, as used in the specification and the appended claims, the singular forms “a,” “an,” and “the” include plural referents unless the context clearly dictates otherwise. Thus, for example, reference to “a support” includes a plurality of supports. In this specification and in the claims that follow, reference will be made to a number of terms that shall be defined to have the following meanings unless a contrary intention is apparent.

Discussion

Embodiments of the present disclosure include integrated sensing probes, systems including the integrated sensing probes, methods of fabricating integrated sensing probes, methods of using integrated sensing probes, integrated sensing and scanning probes and the like. Embodiments of the present disclosure can be used in a number of applications such as, but not limited to: (i) in a static mode measuring transmission, reflection, absorption, scattering, or resonance frequency detuning of a sub-wavelength sensing probe for sensing minute quantities of a sample, (ii) by scanning (i.e., moving in x-, y-, or z-direction) the probe or the sample, while simultaneously or sequentially detecting transmitted, reflected, absorbed, scattered, or resonance frequency detuned signals for imaging with sub-wavelength resolution, (iii) by efficiently transmitting radiation through such a probe, and attaining a high concentration of electromagnetic radiation beyond the standard diffraction limit, which is relevant for next generation optical data storage and read-out in order to increase the capacity of optical data storage media by reducing the size of a bit on a storage medium, or (iv) optically induced material deposition or removal, structuring, etching, or patterning processes that can be performed at sub-wavelength resolution.

Embodiments of the present disclosure can use the integrated sensing probe in a static mode (where the probe does not move and is positioned over a certain portion of the sample or disposed in a flowing sample system), or in a scanning or imaging mode (where the integrated sensing probe can scan/image a plurality of areas of the sample of interest, or where the sample is moved beneath the probe to scan/image a plurality of areas of the sample of interest, while the probe remains static). Embodiments of the present disclosure can be used to detect, analyze, remove, deposit, and/or activate biological targets (e.g., compound, DNA, protein, polypeptide, polynucleotide, whole cell, and the like) or interactions, chemical targets (e.g., compound, drugs, and the like) or interactions, physical targets (e.g., nanoscale objects, quantum dots, quantum wires, quantum rods, composite/microstructured materials, dopants in semiconductors, and the like) or interactions, and technological targets (e.g., information bits in a storage medium, electronic devices, transistors, circuits, memory devices, micromechanical systems, and the like) or interactions.

In particular, embodiments of the present disclosure use the integrated sensing probe to directly detect target compounds (e.g., chemical or biological targets disposed at the sampled surface), indirectly through the target compounds interaction with surface modifications (e.g., surface recognition chemistries, biologies, and the like) at the surface of the sample, and/or indirectly through the target compounds interaction with recognition elements not immobilized at the surface of the sample surface (e.g., recognition chemistries, biologies, and the like). Therefore, labeled or label-free detection of target compounds can be performed using embodiments of the present disclosure. In particular, embodiments of the present disclosure enable label-free detection of target compounds in the terahertz (THz) region and the mid-infrared region of the spectrum, but are also applicable to any frequency range above and beyond this spectral regime (from gamma-waves to radio-waves) by device structure scaling and appropriate material selection. The THz and mid-infrared spectral regime is of particular interest for sensing and analyzing molecules due to the excitation of vibrational and rotational transitions characteristic for molecular species, such as e.g., individual species, ensembles of species, and/or interactions of individual species or ensembles of species (e.g., binding events, conformational changes associated with individual molecules or molecular ensembles, and the like).

In addition, the integrated sensing probe can operate simultaneously or sequentially as sensing probe and a near-field scanning probe such as, but not limited to, an atomic force microscope (AFM), scanning tunneling microscope (STM), scanning electrochemical microscope (SECM), scanning thermal microscope (SThM), and scanning Kelvin probe microscope, or other near-field microscopic techniques. It is advantageous to use a single probe tip to obtain multiple sample parameters in a single sample scan. In addition, combined detection can be used to calibrate, correct, compensate, or expand one set of information with the second information set.

In another embodiment, the integrated sensing probe can be used for optical data storage and read-out applications. In this embodiment, radiation at shorter wavelengths such as, but not limited to, optical/visible or ultraviolet radiation transmitted through and/or reflected by the probe tip can be used to write or read bits of information with sub-wavelength dimensions in a data storage medium, such as, but not limited to, a reversible or a write-once phase change material (e.g., GeₓSb₁₋ₓTe, AgInSbTe, and the like), a photo-modifiable film (e.g., organic dyes, and the like), or an imprinted read-only nanostructure (e.g., in CD-ROM or DVD-ROM media, where bits of information are coded as protuberances or dips along the data storage tracks of a disk, and the like). In this embodiment, the high transmission efficiency of the integrated sensing probe is highly desirable for reducing losses in such a system.

A closely related application is surface structuring and patterning such as e.g., photolithography with sub-wavelength resolution, where structures are defined at selected areas of a substrate by scanning the near field probe, and illuminating the substrate to photoactivate a chemical reaction (e.g., a positive or negative contrast photoresistant material, a photooxidization process, and the like), a material removal process, or a deposition process (e.g., diacetylene photodeposition, ZnS photodeposition, and the like).

In another embodiment, the integrated sensing probe can be used for localized deposition or removal of material, while simultaneously monitoring parameters changing at the sample surface either with the same sensing probe used for structuring, or with an additionally integrated microscopic technique (e.g., AFM, STM, SECM, and the like).

Embodiments of the present disclosure include a sensing system that includes, but is not limited to, a radiation source, an integrated sensing probe disposed adjacent to the radiation source, and a detection system adjacent to or integrated within the integrated sensing probe. The integrated sensing probe includes, but is not limited to, a substrate, a corrugated reflective surface (e.g., a metal coated corrugated surface plasmon polariton coupling structure, and the like), and a coaxial waveguide structure. The corrugated reflective surface (e.g., a circular corrugated reflective surface) and the coaxial waveguide structure are disposed on the substrate. The coaxial waveguide structure is positioned at the center of the corrugated reflective surface (e.g., circular corrugated reflective surface). The coaxial waveguide structure includes, but is not limited to, an efficient coupling structure, a coaxial waveguide, and a coaxial waveguide tip. The corrugated reflective surface includes a reflective layer that extends onto the efficient coupling structure and the coaxial waveguide. The coaxial waveguide includes a coaxial core, a dielectric layer, and a coaxial shield (e.g., a portion of the reflective layer). The coaxial waveguide tip apex is not covered by the reflective layer or the dielectric layer, and is exposed. However, the coaxial waveguide tip can be covered with a separate (e.g., electrically and/or optically insulated) localized layer (e.g., reflective layer, metal layer, electrode layer, immobilized chemical/biochemical/biological layer, and the like) that may serve as an additional sensing tool, such as, but not limited to, an electrode, a STM tip, an AFM tip, and the like. It should also be noted that the coaxial waveguide tip could be modified with a chemical or biological receptor material for additional sensing/probing function simultaneously or sequentially to the near-field optical probe function.

The radiation source can include terahertz radiation sources (3 mm-30 μm wavelength), mid-infrared radiation sources (30 μm-3 μm), near-infrared radiation sources (3 μm-800 nm), optical/visible radiation sources (800 nm-400 nm), UV radiation sources (400 nm-1 nm), but also lower wavelengths extending into X-ray and the gamma-radiation regime (wavelength of about 1 nm to smaller than 0.01 nm), and at higher wavelengths extending into the radio-wave regime (about 100,000 km to 1 mm). The radiation sources can be particularly used for chemical, biochemical, biological, and/or physical sensing in the terahertz and infrared range, but also in all other ranges of the electromagnetic spectrum listed above. In particular, this integrated sensing probe is useful in the infrared and THz range, as in this spectral regime radiation can resonantly probe (macro)molecular vibrational states or rotational states for label-free (bio)molecular identification and chemical recognition of biomolecules, explosives, drugs, polymers, biopolymers, polypeptides, polynucleotides, crystals, and the like, as well as their interaction with other molecules or stimuli, or conformational changes with/without interaction with other molecules or stimuli. The probe can also directly address electronic properties in materials such as, but not limited to e.g., semiconductors for analyzing (nano)electronic devices and circuits.

The radiation sources can be used for chemical, biochemical, biological, and/or physical sensing in the IR range, which is advantageous due to the inherent molecular selectivity resulting from the excitation of fundamental rotational and vibrational molecular modes. In addition, embodiments of the present disclosure enable chemical sensing in the about 3 to 20 μm spectral range, which provides access to the unique absorption patterns characteristic for many organic compounds. Furthermore, embodiments of the present disclosure enable sensing at near-infrared and optical/visible frequencies, which is attractive for fluorescent label-based chemical and biochemical sensing. Applications for optical data storage and photolithographic applications rely on the use of the present disclosure in the optical/visible and UV frequency range. Upon scaling of the probe structure and appropriate material choice, embodiments of the present disclosure are also applicable to sense in the optical/visible radiation range, the UV radiation range, the gamma-radiation range, and the radio-wave range.

In a few particular embodiments, the radiation source can include terahertz radiation sources, mid-infrared radiation sources, near-infrared radiation sources, optical/visible radiation sources, UV radiation sources, as well as radiation sources with wavelengths shorter than the UV, and larger than the THz regime. The terahertz radiation sources can include, but are not limited to, photoconductive, electro-optic or parametric mixing of pulsed or cw lasers, fundamental electronic oscillators, electronic multiplier chains, electronic mixing, backward wave oscillators, gas lasers (e.g., CO and CO₂), quantum cascade lasers, Bloch oscillators, plasmonic oscillators, or internal mixing in semiconductor laser structures, and the like. The radiation emitted from the terahertz radiation source can range from 3 to 300 cm⁻¹ (i.e., 0.1-10 THz). The radiation source can emit light at a single wavelength, or at multiple wavelengths. In an embodiment, the radiation can be at 345 GHz, 650 GHz, 850 GHz, 1.8 THz, 2.1 THz, and/or 2.8 THz.

The mid-infrared radiation source can include, but is not limited to, quantum cascade lasers, lead salt laser, CO₂ laser, Er:YAG lasers, optical parametric oscillators (OPO), LEDs, and multiwavelength/broadband light sources (e.g., blackbody filaments, SiC filaments, NiCr wires, and the like). The radiation source can emit light at a single wavelength, or at multiple wavelengths. The wavelength can include a single wavelength or multiple wavelengths from about 3 to 1000 μm, and any range within this wavelength range, which can include, but is not limited to, about 2 to 5, about 2 to 12, about 5 to 8, about 5 to 12, about 5 to 15, about 5 to 20, about 8 to 12, about 8 to 15, about 8 to 20, about 2 to 15, about 2 to 20, about 10 to 20, about 10 to 50, about 20 to 50, about 20 to 100, about 50 to 100, about 50 to 200, and about 100 to 1000 μm.

Near-infrared, optical/visible, and UV radiation sources can include, but are not limited to, light-emitting diodes, laser diodes, lasers, plasma lamps, arc lamps, and the like. The radiation emitted from these sources can be about 3 μm to 1 nm. In particular, the radiation can have a wavelength of 242 nm (e.g., for biosensing, and the like), 405 nm (e.g., for optical data storage, and the like), 528 nm and 532 nm (Ar⁺ laser line and frequency doubled Nd:vanadate laser lines, and the like), and 628 nm (HeNe laser line, and the like).

In particular, the radiation source is a quantum cascade laser that can emit at a single wavelength. The wavelength can include, but is not limited to, about 2 to 5, about 2 to 12, about 5 to 8, about 5 to 12, about 5 to 15, about 5 to 20, about 8 to 12, about 8 to 15, about 8 to 20, about 2 to 15, about 2 to 20, about 10 to 20 μm and about 50 μm to 1 mm.

The radiation source (or the EM source) produces radiation (e.g., terahertz radiation, 3-300 cm⁻¹ and mid infrared radiation, 300-4000 cm⁻¹) that is directed at the backside of the integrated sensing probe, which is the side opposite the coaxial waveguide structure. In an embodiment, the radiation can be split and directed toward the integrated sensing probe and the detection system. The radiation passes through the substrate and couples to surface plasmon polaritons at the corrugated reflective surface, and is guided to the efficient coupling structure and through the coaxial waveguide to the coaxial waveguide tip. To increase the lateral resolution for near-field sensing, radiation guided by the coaxial waveguide is transmitted through the coaxial waveguide tip having a sub-wavelength aperture (e.g., 10 nm to 100 μm, or as appropriate for the radiation used in a particular embodiment). The coaxial waveguide tip also allows for a fixed-height scanning gap (e.g., 1 nm to 100 μm, or as appropriate for the radiation used in a particular embodiment) between the coaxial waveguide tip and the sample surface to be achieved. The corrugated reflective surface and the coaxial waveguide are designed (e.g., number of ridges, height, width, period, and the like) to increase the transmission coupling efficiency to surface plasmon polariton modes, and the transmission of radiation through the sub-wavelength-size coaxial waveguide tip.

As mentioned above, the integrated sensing probe includes a substrate. The substrate can be made of a material that is transparent to terahertz radiation, mid-infrared radiation, near-infrared, optical/visible, and/or UV radiation, as well as for other frequencies above and beyond extending into the gamma-wave and radio-wave regime, as noted above. In an embodiment, the material may be transparent to one or more specific wavelength ranges within those noted above (e.g., a sub-range of terahertz radiation, and the like), and absorbs at other wavelengths within the broader range noted above (e.g., absorbs at other wavelengths excluding the sub-range). It should also be noted that a thin layer of oxide (e.g., silicon oxide when the material is silicon) could form between one or more layers (e.g., between the substrate and the corrugation support layer). Such a thin layer is transparent in all frequency ranges described above. Its influence can therefore be neglected to a large extent, as it only leads to a small change in the optimal lateral corrugation periodicity, which can be neglected in all but the UV radiation embodiment and shorter wavelengths extending into the gamma-wave regime.

In an embodiment, the substrate is made of a material transparent to terahertz radiation. The substrate can be made of a material selected from, but not limited to, high resistivity silicon (0.1 THz-10 THz), high resistivity gallium arsenide (0.1-6 THz), high resistivity germanium, other high resistivity semiconductors, ZnTe, GaSe, silica, quartz, sapphire, non-polar polymers (e.g., polycarbonate, polyimide, and the like), and combinations thereof, that are transparent to terahertz radiation or specific wavelengths of terahertz radiation.

In an embodiment, the substrate is made of a material transparent to mid-infrared radiation. The substrate can be made of a material selected from: materials or material composites such as, but not limited to, GaAs, AlGaAs (e.g., AlₓGa₁₋ₓAs, where x is from 0.001 to 0.999), AlAsSb, InAs, InP, InSb, Sb, InSb, AlAs, AlInAs, GaInAs, AlSb, GaSb, InAs, SiGe, GaN, AlN, AlGaN, InGaN, GaP, ZnSe, ZnS, Ge, Si, SiO₂, sapphire/Al₂O₃, CaF₂, BaF₂, NaCl, GeAsSe (in various compositions), AgCl, AgBr, AgI, AgCl/AgBr (in various compositions), AgCl/AgBr/AgI (in various compositions), KBr, CsI, TIBr, TlI, TIBr/TlI (in various compositions), diamond/C, diamond-like carbon, polyethylene, methylpentene resin, and other IR-transparent polymers, as well as other IR-transparent materials that are known in the art. It should be noted that the ratio of the components in the materials or composites thereof could be at any chemically appropriate ratio as known in the art. For example, GaₓAsₓ₋₁, AlₓGa₁₋ₓAs, AlₓAsₓ₋₁Sb, and so on, where x is from 0.001 to 0.999. It should be noted that subscripts are not included for each of the compounds or composites. This does not indicate that they are present in a 1 to 1 ratio, but rather at a chemically appropriate ratio as known in the art. The wavelength can include a single wavelength or multiple wavelengths from about 2 to 1000 μm and any range within this wavelength range, which can include, but is not limited to, about 2 to 5, about 2 to 12, about 5 to 8, about 5 to 12, about 5 to 15, about 5 to 20, about 8 to 12, about 8 to 15, about 8 to 20, about 2 to 15, about 2 to 20, about 10 to 20, about 10 to 50, about 20 to 50, about 20 to 100, about 50 to 100, about 50 to 200, and about 100 to 1000 μm.

In an embodiment, the substrate is made of a material transparent to near-infrared, optical/visible, or UV radiation, as well as for other frequencies above and beyond extending into the gamma-wave and radio-wave regime, as noted above. The substrate can be made of a material selected from: fused silica, quartz, sapphire, high quality glasses (e.g., BK7), polycarbonate or other transparent polymers, diamond, SiC, GaN and other high bandgap semiconductors, and combinations thereof that are transparent to near-infrared, optical/visible or UV radiation or specific wavelengths at 242 nm, 405 nm, 528 nm, 532 nm, 628 nm.

In an embodiment, the substrate is made of a material transparent to two or more of the wavelength ranges or portions thereof noted above. For example, the substrate is made of a material transparent to both terahertz radiation and mid-infrared radiation. In this regard, the substrate can be made of a material selected from, but not limited to, high resistivity silicon (any frequency apart from the silicon Bremsstrahlen region around 15 THz), high resistivity gallium arsenide (any frequency apart from the GaAs Bremsstrahlen region around 8-10 THz), high resistivity germanium arsenide (any frequency apart from the Ge Bremsstrahlen region around 9 THz), and combinations thereof that are transparent to both terahertz and mid-infrared radiation or specific wavelengths of terahertz and mid-infrared radiation. As another example, the material is transparent to terahertz radiation, mid-infrared radiation, near-infrared, optical/visible, and UV radiation. In this regard, the substrate can be made of sapphire, which is transparent in selected regions of the THz spectrum and transparent from mid-infrared to UV frequency ranges (1650 cm⁻¹-50,000 cm⁻¹), for example.

The substrate can have a thickness of about 10 nm to 10 mm, a length of about 1 μm to 5 mm, and a width of about 1 μm to 5 mm. In most cases, a thickness of ¼ of the wavelength, or ¼ of the wavelength+n-times ½ of the used frequency range can be used to minimize the direct reflection from the probe to enhance the coupling to the near-field tip. As the substrate size becomes very thin at optical/visible and UV frequencies, alternative manufacturing sequences can be used for this case by locating the corrugated reflection surface at the top surface of the substrate, in order to allow the use of thicker substrates. However, in this alternative embodiment, the coaxial waveguide tip has to transverse from one side of the substrate to the other.

In an embodiment, the substrate is covered by a separation layer such as e.g., a native oxide layer on a substrate, a buried silicon dioxide layer of an SOI wafer, and the like, which is transparent to electromagnetic radiation in the desired operation frequency range. This layer provides a chemical contrast to the substrate and coaxial tip structure, in order to facilitate the manufacturing process, e.g. by providing the possibility to act as an etch stop layer during manufacturing of the coaxial waveguide tip.

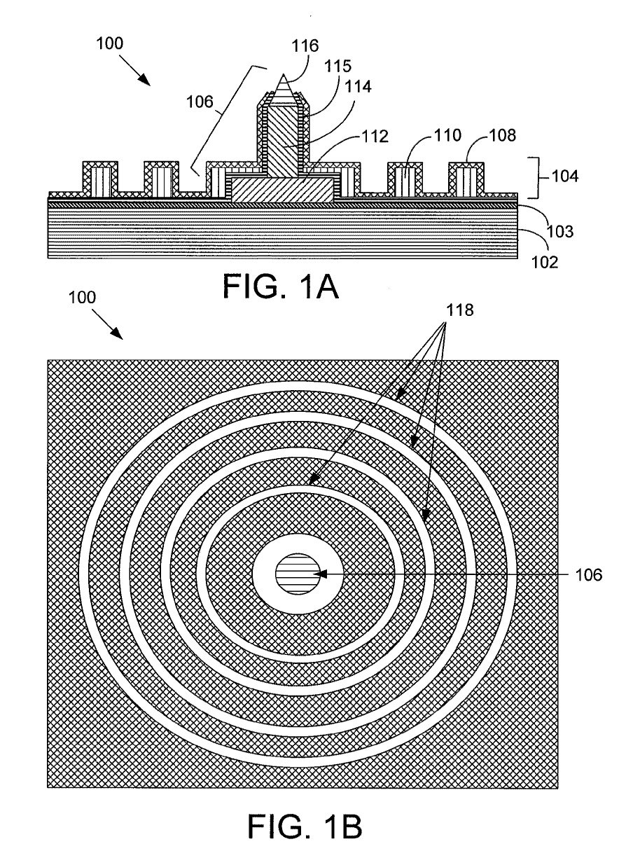

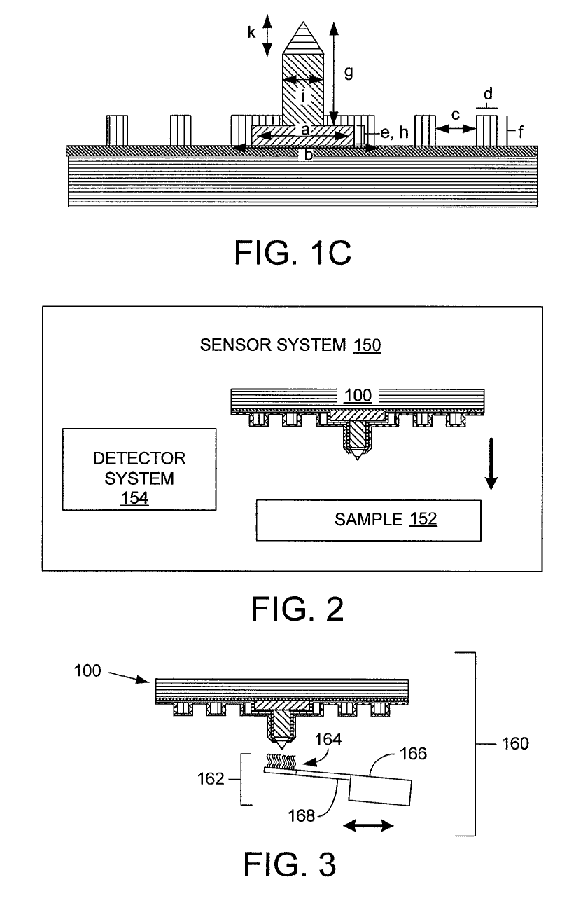

As mentioned above, the integrated sensing probe includes a corrugated reflective surface disposed on the substrate. The corrugated reflective surface functions to enhance transmittance of the radiation through a sub-wavelength tip by coupling the radiation to surface plasmon polaritions at the corrugated reflective surface. In particular, corrugated reflective surface functions to (i) couple free-space radiation to a surface plasmon polariton (SPP) mode at the reflective layer-dielectric interface, (ii) concentrate the SPP electric field at the coaxial waveguide structure or coaxial waveguide tip to achieve a field enhancement, and (iii) couple the enhanced field into a sub-wavelength aperture or waveguide (e.g., like the coaxial waveguide described within this embodiment) to increase transmittance through the sub-wavelength structure. The corrugated reflective surface includes a plurality of ridges concentric (e.g., circular ridges) around the coaxial waveguide structure, where each ridge has a center at the position of the coaxial waveguide structure. Depending on the polarization state of the incoming radiation, it can be useful to orient the ridges in a symmetric or asymmetric fashion with respect to the center position of the coaxial structure along the polarization plane of the incoming radiation, i.e., in a particular configuration of the ring structures can be both ridge or both trenches at the same radial position of opposite sides (symmetric case) or opposite sides of the ring structures could exhibit ridges at one side while trenches are places on the opposite side (case asymmetric). The dimensions of the corrugated reflective surface include the height of the ridges (FIG. 1C, f), the width of the ridges (FIG. 1C, d), and the width of the groves between the ridges (FIG. 1C, c), as well as the diameter of the circular ridges (or period of the circular ridges). FIG. 1C is discussed in greater detail in Example 1. The height of the ridges is less than the height of the coaxial waveguide, so that the corrugated reflective surface does not touch the sample or sample support. The dimensions of the corrugated reflective surface (See FIG. 1C) are determined by the number of ridges, and the wavelength of the radiation that is to be coupled to the surface plasmon polariton mode at the reflective layer-dielectric interface of the corrugated reflective surface. In this regard, the number of ridges and the dimensions of the ridges can be calculated in a manner described in more detail in Example 1 and FIG. 1C for a particular wavelength. In that Example, the dimensions are calculated based on terahertz radiation, but the same calculations can be applied to all other wavelengths of radiation to determine the appropriate or optimal dimensions of the corrugated reflective surface, and the number of ridges.

In a particular embodiment, the dimensions of the corrugated reflective surface for the terahertz radiation range from 15 cm⁻¹ to 60 cm⁻¹ using high resistivity silicon as the substrate are, the following: the height of each ridge is about 5 μm to 200 μm, the period of the ridges (width of each ridge+space between ridges) is 50 μm at 60 cm⁻¹ to 200 μm at 15 cm⁻¹, the width between each ridge is about 20% to 80% of the ridge period, and the diameter of the first ridge is between 0*λ and 1*λ, preferably around ¾*λ, where λ is the wavelength of the employed radiation. The number of ridges is typically between 1 and 50.

In a particular embodiment, the dimensions of the corrugated reflective surface for the mid-infrared radiation range from 3 μm to 30 μm are the following for a substrate with a refractive index n: the height of each ridge is about 100 nm to 15 μm, the period of the ridges (width of each ridge+space between ridges) is 3 μm/n at 3 μm wavelength to 30 μm/n at 3 μm, the width between each ridge is about 20% to 80% of the ridge period, and the diameter of the first ridge is between 0*λ and 1*λ, preferably around ¾*λ, where λ is the wavelength of the employed radiation. The number of ridges is typically between 1 and 500.

In a particular embodiment, the dimensions of the corrugated reflective surface for the near-infrared radiation range from 800 nm to 3 μm are the following: the height of each ridge is about 20 nm to 1.5 μm, the period of the ridges (width of each ridge+space between ridges) is around λ/n, the width between each ridge is about 20% to 80% of the ridge period, and the diameter of the first ridge is between 0*λ and 1*λ, preferably around ¾*λA, where λ is the wavelength of the employed radiation. The number of ridges is between typically 1 and 500.

In a particular embodiment, the dimensions of the corrugated reflective surface for the optical/visible radiation range from 400 nm to 800 nm are the following: the height of each ridge is about 10 nm to 800 nm, the period of the ridges (width of each ridge+space between ridges) is around λ/n, the width between each ridge is about 20% to 80% of the ridge period, and the diameter of the first ridge is between 0*λ and 1*λ, preferably around ¾*λ, where λ is the wavelength of the employed radiation. The number of ridges is between typically 1 and 500.

In a particular embodiment, the dimensions of the corrugated reflective surface for the UV frequency range from 400 nm to 1 nm are the following: the height of each ridge is about 0.1 nm to 200 nm, the period of the ridges (width of each ridge+space between ridges) is around λ/n, the width between each ridge is about 20% to 80% of the ridge period, and the diameter of the first ridge is between 0*λ and 1*λ, preferably around ¾*λ, where λ is the wavelength of the employed radiation. The number of ridges is between typically 1 and 5000.

The same calculations apply to frequencies above and beyond the EM ranges listed above, extending into the gamma-wave and radio-wave regime.

The corrugated reflective surface includes a material with a large negative imaginary part of the dielectric function, i.e., a large conductivity, in the desired frequency of operation. It can include, but is not limited to, metallic layers, doped semiconductor layers, conductive silicides, and the like for THz or MIR frequency operation disposed over the ridges. The function of the reflective layer is to provide a reflective layer-dielectric interface to confine the SPP mode at this interface. The reflective layer is continuous over the ridges, but the reflective layer has an opening at the coaxial waveguide tip, which will be described in more detail in other portions of the application. The thickness of the reflective layer depends, at least in part for defining a minimal thickness, upon the skin depth of the metallic layer at the desired frequency range to prevent leakage of radiation through the layer. The reflective layer can have a thickness of about 1 to 10 skin depths at the desired frequency of operation, where the skin depth δ can be calculated from following formula:

$$δ = \frac{1}{\sqrt{π f μσ}} ,$$

where f is the frequency of operation, μ the permeability of the material and σ the conductivity of the metallic material. In an embodiment where the reflective layer is a gold metal layer and the radiation is terahertz radiation, the thickness is about 0.15 to 12.6 μm, 0.3 to 5.6 μm, and 0.4 to 4.0 μm. However, the reflective layer thickness could vary depending on the exact frequency, the material that the metal layer is made of, the dimensions of the various components of the integrated sensing probe. The appropriate reflective layer thickness can be calculated using the formula above.

The metal layer can be made of a high conductivity material such as, but not limited to, following metals: gold, silver, copper, platinum, aluminum, and the like, or following highly doped semiconductors: silicon, polysilicon, GaAs, Ge, SiGe, InP, InGaAs, GaN, metallic suicides, and the like. It should be noted that the “reflective layer” is sometimes be referred to as a “metal layer”, but it is understood that reference to “metal layer”, if appropriate for a particular embodiment, can be extended to other embodiments, where the “reflective layer” includes materials other than metals.

In a particular embodiment, the reflective surface is a gold layer. In an embodiment, the metal layer of the corrugated reflective surface is disposed onto raised and/or depressed portions of the substrate (not shown in the figures), which defines the dimensions of the circular ridges. In an embodiment, the metal layer of the corrugated reflective surface is disposed onto raised and/or depressed on a corrugation support layer (shown in FIGS. 1A and 1C), which defines the dimensions of the circular ridges. The dimensions of the corrugation support layer (FIG. 1C, f, d, and c), or the substrate are consistent with producing the embodiments of the corrugated reflective surface as defined above. In general, the dimensions of the corrugation support layer or the substrate in addition to the dimension of the reflective layer correspond to the determined dimensions of the corrugated reflective surface as defined before. It should also be noted that the corrugation support layer could cover a portion of the coaxial waveguide structure (e.g., the efficient coupling structure and/or the coaxial waveguide, and the like).

The corrugation support layer is made of a material that is transparent or has low losses to radiation in the terahertz, mid-infrared, near-infrared, optical/visible, UV, or frequencies above and beyond the EM ranges listed herein, extending into the gamma-wave and radio-wave regime. In an embodiment, the corrugation support layer material may be transparent to one or more specific wavelength ranges within those noted above (e.g., a sub-range of terahertz radiation, and the like) and absorbs at other wavelengths within the broader range noted above (e.g., absorbs at other wavelengths excluding the sub-range). In an embodiment, the corrugation support layer material may include a photolithographically definable or otherwise structurable or patternable material such as, but not limited to, SU-8, benzocylobutene (BCB), negative or positive photoresists, poly-methyl-metacrylate (PMMA), and the like for simplifying manufacturing procedures.

In an embodiment, the corrugation support layer is made of a material transparent to terahertz radiation. The corrugation support layer can be made of a material selected from, but not limited to, high resistivity silicon (0.1 THz-10 THz), high resistivity gallium arsenide (0.1-6 THz), high resistivity germanium, and other high resistivity semiconductors, ZnTe, GaSe, silica, quartz, sapphire, transparent polymers (e.g., polycarbonate, polyimide, an the like), or organic compounds (e.g., positive or negative photoresist materials, nano-imprint materials, PMMA, BCB, and the like), and the like, as well as combinations thereof that are transparent to terahertz radiation or specific wavelengths of terahertz radiation.

In an embodiment, the corrugation support layer is made of a material transparent to mid-infrared radiation. The substrate can be made of a material selected from: materials or material composites such as, but not limited to, GaAs, AlGaAs (e.g., AlₓGa₁₋ₓAs, where x is from 0.001 to 0.999), AlAsSb, InAs, InP, InSb, Sb, InSb, AlAs, AlInAs, GaInAs, AlSb, GaSb, InAs, SiGe, GaN, AlN, AlGaN, InGaN, GaP, ZnSe, ZnS, Ge, Si, SiO₂, sapphire/Al₂O₃, CaF₂, BaF₂, NaCl, GeAsSe (in various compositions), AgCl, AgBr, AgI, AgCl/AgBr (in various compositions), AgCl/AgBr/AgI (in various compositions), KBr, CsI, TlBr, TlI, TlBr/TlI (in various compositions), diamond/C, diamond-like carbon, polyethylene, methylpentene resin, and other IR-transparent polymers, as well as other IR-transparent materials that are known in the art. It should be noted that the ratio of the components in the materials or composites thereof could be at any chemically appropriate ratio as known in the art. For example, GaₓAsₓ₋₁, AlₓGa₁₋ₓAs, AlₓAsₓ₋₁Sb, and so on, where x is from 0.001 to 0.999. It should be noted that subscripts are not included for each of the compounds or composites. This does not indicate that they are present in a 1 to 1 ratio, but rather at a chemically appropriate ratio as known in the art. The wavelength can include a single wavelength or multiple wavelengths from about 2 to 1000 μm and any range within this wavelength range, which can include, but is not limited to, about 2 to 5, about 2 to 12, about 5 to 8, about 5 to 12, about 5 to 15, about 5 to 20, about 8 to 12, about 8 to 15, about 8 to 20, about 2 to 15, about 2 to 20, about 10 to 20, about 10 to 50, about 20 to 50, about 20 to 100, about 50 to 100, about 50 to 200, and about 100 to 1000 μm.

In an embodiment, the corrugation support layer is made of a material transparent to near-infrared, optical/visible or UV radiation. The corrugation support layer can be made of a material selected from: fused silica, quartz, sapphire, high quality glasses (e.g., BK7), transparent polymers (e.g., polycarbonate, polyimide, an the like), or organic compounds (e.g., positive or negative photoresist materials, nano-imprint materials, PMMA, BCB, and the like) for the frequency range of operation, wide bandgap semiconductors such as, but not limited to, diamond, SiC, GaN, and combinations thereof, that is transparent to near-infrared, optical or UV radiation or specific wavelengths of 242 nm, 405 nm, 528 nm, 532 nm, and/or 628 nm.

In an embodiment, the corrugation support layer is made of a material transparent to two or more of the wavelength ranges or portions thereof noted above. For example, the corrugation support layer is made of a material transparent to both terahertz radiation and mid-infrared radiation. In this regard, the corrugation support layer can be made of a material selected from: high resistivity silicon (any frequency apart from the silicon Bremsstrahlen region around 15 THz, and up to 250 THz), high resistivity gallium arsenide (any frequency apart from the GaAs Bremsstrahlen region around 8-10 THz, and up to 400 THz), high resistivity germanium (any frequency apart from the Ge Bremsstrahlen region around 9 THz, and up to 180 THz), and combinations thereof, that is transparent to both terahertz and mid-infrared radiation or specific wavelengths of terahertz and mid-infrared radiation. As another example, the material is transparent to terahertz radiation, mid-infrared radiation, near infrared, optical and UV radiation. In this regard, the corrugation support layer can be made of sapphire, which is transparent in selected regions of the THz spectrum and transparent over the mid infrared to UV frequency ranges (1650 cm⁻¹-50,000 cm⁻¹), for example.

In an embodiment, materials suitable above and beyond the EM frequency regimes listed above maybe selected, extending into the gamma-wave and radio-wave regime.

The corrugation support layer can be formed using techniques such as, but not limited to, lamination, spin coating, extrusions, roller coating, meniscus coating, photo-definition, wet chemical etching, dry plasma etching, thermally-induced refractive index gradients, ion implantation, molecular beam epitaxy (MBE), metal-organic chemical vapor deposition (MOCVD), hydride vapor phase epitaxy (HVPE), atomic layer deposition (ALD), low pressure chemical vapor deposition (LPCVD), plasma enhanced chemical vapor deposition (PECVD), RF sputtering, DC sputtering, evaporation, nano-imprint, laser ablation, and the like, as well as combinations thereof.

As mentioned above, the integrated sensing probe includes the coaxial waveguide structure. The coaxial waveguide structure includes, but is not limited to, an efficient coupling structure, a coaxial waveguide, and a coaxial waveguide tip. The coaxial waveguide includes an inner core (coaxial core), a dielectric isolation layer disposed on the inner core, and a shield layer (reflective layer) disposed at the dielectric layer. This layer can, but is not limited to, be the corrugated reflective surface that extends to the coaxial waveguide to fulfill the role of the conductive outer cladding (i.e., the coaxial waveguide shield) of the coaxial waveguide structure, or a reflective layer of another type of material. As mentioned above, the coaxial waveguide tip is not covered by the reflective layer or the dielectric layer.

The efficient coupling structure is disposed directly on the substrate, or on a separation layer, which aids the technological manufacturing process (as shown in FIGS. 1A and 1C). The efficient coupling structure increases the coupling efficiency of the concentrated SPP electric field into the coaxial waveguide. The efficient coupling structure has typically a length and width (FIG. 1C, a) around half of a wavelength, related to the surrounding dielectric material, for the desired frequency. The efficient coupling structure can be made of material such as, but not limited to, highly doped semiconductors (e.g., silicon, GaAs, InP, Ge, SiGe, and the like), metals (e.g., gold, silver, platinum, copper, and the like), or a metallic silicide, and the like, as well as combinations thereof. The efficient coupling structure can have a circularly symmetric shape as described in Example 1 (FIG. 1C, b, f), leading to a circular shape when observed from top. For polarization selective coupling, rectangular, elliptic, triangular, and other circularly asymmetric shapes can also be used. The structure can be symmetric with respect to the coaxial coupler line, or asymmetric, in order to allow efficient coupling with different states of polarization of the incident radiation.

The coaxial waveguide structure is disposed on the efficient coupling structure. The coaxial waveguide structure functions to guide the electric field from the SPP coupling side of the device to the coaxial waveguide tip. The coaxial waveguide has a length (FIG. 1C, g) of about 2 to 100 μm, and a diameter (FIG. 1C, i) of about 200 nm to 30 μm. As mentioned above, the coaxial waveguide structure includes the inner core, the dielectric layer disposed on the inner core, and a shield layer (reflective layer). The inner core can be made of material such as, but not limited to, a highly doped semiconductor (e.g., silicon, GaAs, InP, Ge, SiGe, and the like), a metal (e.g., gold, silver, platinum, copper, and the like), or a metallic suicide, and the like, as well as combinations thereof. The dielectric layer can be made of material such as, but not limited to, a high resistivity or low-doped semiconductor such as, but not limited to silicon, polysilicon, Ge, or a dielectric material such as, but not limited to SiO₂, Si₃N₄, polymers or photoresist materials, and the like, as well as combinations thereof, as long as they are transparent to the desired frequency range. In an embodiment, the efficient coupling structure and the coaxial waveguide are made of the same material.

The coaxial waveguide tip is the end portion of the coaxial waveguide that is formed in a point and is partially covered by the metal layer and/or the dielectric layer. The coaxial waveguide tip starts at about the area, where the diameter of the coaxial waveguide tapers. The metal layer and the dielectric layer extend up to about the area of the coaxial waveguide, where the diameter of the coaxial waveguide tapers, but not to the tip apex. A sub-wavelength aperture is defined, where the metal layer and the dielectric layer end. The sub-wavelength aperture can be positioned anywhere between the coaxial waveguide tip apex and where the coaxial waveguide tapers. The position of the sub-wavelength aperture is determined by the radiation frequency and the desired spatial resolution of the probing tip. The sub-wavelength aperture is defined at near the waveguide tip apex so that the radiation can focus on the tip apex with minimized radiation power loss by diffraction. The size of the sub-wavelength aperture is determined by the thickness of the dielectric layer on the inner core, the inner core size, and the aperture position on the tapered coaxial waveguide tip. As the wavelength of the radiation is reduced, a smaller aperture needs to be positioned closer to the tip apex to achieve probing resolution below the diffraction limit. The coaxial waveguide tip functions to provide a geometric singularity, which yields a very high electric field amplitude, and it functions as a sensing tip by spacing the coaxial waveguide tip at an optimized and deliberately selected distance above the sample surface.

The coaxial waveguide tip has a length (FIG. 1C, k) of about 1 to 30 μm or about 1 to 10 μm, and a diameter (FIG. 1C, i) of about 200 nm to 30 μm. It should be noted that the dimensions of the coaxial tip could be adjusted according to the frequency range used in a particular embodiment to achieve below diffraction limit resolution. The coaxial waveguide tip core and shield layer (reflective layer) can be made of a conductive material such as, but not limited to, metals (e.g., gold, aluminum, platinum, copper, and the like), or of doped semiconductors (e.g., silicon, polysilicon, Ge, GaAs, Inp, GaN, and the like), or a metallic suicide, and the like, as well as combinations thereof. In an embodiment, the coaxial waveguide outer core and the coaxial waveguide tip are made of the same material. In another embodiment, the shield layer and the coaxial waveguide tip are made of different materials.

The detection system functions to detect changes in the radiation signal or the radiation itself, where such change can be attributed to interaction of the radiation with the sample. In general, the integrated sensing probe can be used in at least four possible detection modes. First, the integrated sensing probe can detect the transmitted signal in a transmission or scattering geometry. Second, the integrated sensing probe can measure the reflection change of radiation signals impinging on the integrated sensing probe by a sample under the coaxial waveguide tip. Third, the integrated sensing probe can measure the influence of a sample under the coaxial waveguide tip after integrating the coaxial waveguide tip into a resonant cavity, which is detuned by the tip to sample interaction. Fourth, a detection device such as an integrated oscillator may be directly integrated into the near-field tip for near-field detection. The transmitted signals, reflected signals, and/or cavity signals originating from the coaxial waveguide tip interaction with the sample under study can be detected using detection systems such as, but not limited to, photoconductive devices, photodiodes, photomultipliers, camera systems, photonic mixing devices, heterodyne detectors, wave guide antenna, electromagnetic bandgap antenna, bolometric and microbolometric devices, pyroelectric devices, electro-optic detection technologies, cooled or uncooled thermal detectors (e.g., thermopile, and the like), (photovoltaic or photoconductive) semiconductor detectors (e.g., Hg—Cd—Te detector, InSb detector, Ge detector, and the like), pyroelectric detectors, DTGS detectors, (micro)bolometers, integrated oscillators, quantum detectors (e.g., quantum well infrared photoconductive devices (QWIP), and the like), and the like. Appropriate collection optics such as, but not limited to, lenses, prisms, mirrors, Cassegrain objectives, microscope objectives, fibres, gratings, waveguides, and the like, can be used to guide the signal to be detected to the detector and to gather a signal from a larger collection angle when the signal is transmitted, reflected or scattered by the probing tip.

In an embodiment, the terahertz radiation detector can include, but is not limited to, cooled or uncooled photoconductive antennas, THz camera systems, heterodyne detectors, mixers, waveguide antenna, electromagnetic bandgap antenna, bolometric and microbolometric devices, pyroelectric devices, electro-optic detection technologies, integrated oscillators, Golay cells, thermopiles, QWIPs, and the like.

In an embodiment, the mid-infrared radiation detector can include, but is not limited to, cooled or uncooled thermal detectors (e.g., thermopile, and the like), (photovoltaic or photoconductive) semiconductor detectors (e.g., Hg—Cd—Te detector, InSb detector, Ge detector, and the like), pyroelectric detectors, DTGS detectors, (micro)bolometers, integrated oscillators, quantum detectors (e.g., quantum well infrared photoconductive devices (QWIP), and the like), and the like. In addition, an optic system (e.g., optics, direct butt-coupling/pig-tailing, integrated optics, grating couplers, prisms, and the like) can be appropriately position to detect the signal. Optic systems are known in the art.

In an embodiment, the near-infrared, optical/visible or UV detector can include, but is not limited to, cooled or uncooled photodiodes, photomultipliers, CCD cameras, CMOS cameras, avalanche photodiodes, microchannel plates, and the like.

In an embodiment, detectors and optics suitable above and beyond the EM frequency regimes listed above maybe selected, extending into the gamma-wave and radio-wave regime.

FIG. 1A illustrates a cross-sectional view of an embodiment of an integrated sensing probe 100. The integrated sensing probe 100 includes, but is not limited to, a substrate 102, a separation layer 103, a corrugated reflective surface 104, and a coaxial waveguide structure 106. The corrugated reflective surface 104 and the coaxial waveguide structure 106 are disposed either directly on the substrate 102 (not shown) or on a separation layer 103 (shown). The coaxial waveguide structure 106 is positioned at the center of the circular corrugated reflective surface 104. The corrugated reflective surface 104 includes, but is not limited to, a reflective layer 108 and a corrugation support layer 110. The coaxial waveguide structure 106 includes, but is not limited to, an efficient coupling structure 112, an inner core 114, a dielectric layer 115, a shield layer 108 (reflective layer), and a coaxial waveguide tip 116. The dielectric layer 115 can extend on the inner core 114 and parts of the waveguide tip 116 only (not shown), or it can also cover the efficient coupling structure 112 and separation layer 103 (shown) to simplify fabrication. The dimensions of the various components, the material that the components can be made of, as well as the function of the components are described above.

FIG. 1B illustrates a top view of the integrated sensing probe 100, where the white portions correspond to the ridges 118 of the corrugated reflective surface 104. The corrugated reflective surface 104 includes a plurality of circular ridges 118 concentric around the coaxial waveguide structure 106, where each circular ridge 118 has a center at the position of the coaxial waveguide structure 106.

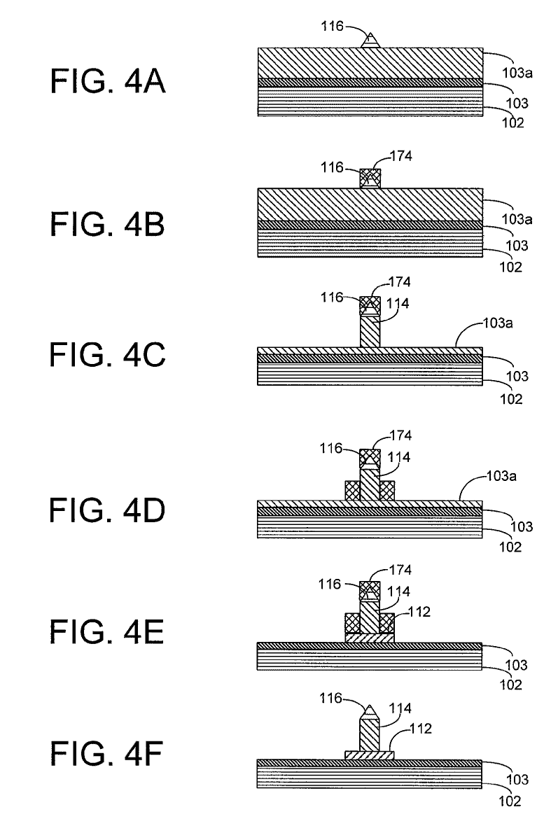

FIG. 2 illustrates an embodiment of a sensor system 150 that includes an embodiment of an integrated sensing probe 100, a sample 152, and a detection system 154. The integrated sensing probe 100 can be positioned over the sample by moving the integrated sensing probe 100 along the x-axis and y-axis (the plane of the sample 152). In addition, the integrated sensing probe 100 can be moved along the z-axis (perpendicular to the sample along the arrow noted in FIG. 2). The detector system 154 can include collection optics as described above and can be positioned below the sample 152 to measure the transmission through the aperture if the samples substrate is partially transparent. It can be positioned beside of the sample 152 to measure scattered signals. It can be positioned above the sample 152 on the substrate side to measure the reflected radiation. It can be coupled to the resonator above the probing tip to measure the detuning of the resonance by the probing tip. The complete sensor system or parts of the sensor system (e.g., only the lower side of the probe or only the sensing probe and collection optics are introduced into a different environment) can be operated in a standard atmosphere environment, in a low or high temperature environment, in a vacuum environment, or in a liquid environment.

The sample 152 can include one or more substances of interest (e.g., liquids, solids, gases, supercritical fluids, and the like) disposed on an appropriate sample substrate or within a medium of interest (e.g., a liquid mixture, a gas mixture, a vacuum volume, and the like). The substances can include one or more compounds of interest. Embodiments of the present disclosure can be used to detect or identify target compounds, such as, but not limited to, compounds that have a vibrational pattern, rotational pattern, a phonon pattern, a resonant electronic transition pattern, a dielectric relaxation pattern or a conductivity pattern. In particular, the target compound can include, but is not limited to, chemicals, biomolecules, entire biological organisms, whole cells, membranes, tissues, and the like. In particular, the target compounds can include, but are not limited to, halogenated hydrocarbons, aromatic hydrocarbons, volatile organic compounds, surfactants, polycyclic aromatic hydrocarbons (PAHs), pesticides, macromolecules, pathogens, toxins, nerve agents, chemical/biochemical/biological warfare agents, antigens, proteins, enzymes, DNA, RNA, viruses, spores, bacteria, cells, neurotransmitters, signaling molecules, metabolites, and the like.

The sample 152 to be analyzed or detected can also include an artificial object, such as, but not limited to, a semiconductor device, transistor, memory, circuits or an optical memory bit in an optical memory device. The sample 152 can also be an object, on which the transmitted highly localized electromagnetic radiation induces a local change, such as, but not limited to, writing a bit on optical memory device or photoexciting a chemical reaction or activating a photodeposition/photoablation/photooxidation process.

The sample 152 to be analyzed can also indirectly generate a signal by interaction with an appropriate recognition chemistry at the sample surface such as, but not limited to, biological targets (e.g., compound, DNA, RNA, protein, polypeptide, polynucleotide, whole cell, and the like), chemical targets (e.g., compound, drugs, and the like), and the like.

In general, a sample including the substance of interest is disposed on or comes into close proximity with (e.g., interacts with a surface modification or a recognition element) the coaxial waveguide tip 116 of the integrated sensing probe 100. For example, the substance of interest is a liquid that includes target compounds to be detected. However, it may also be a gas, a solid, another aggregation state, and/or mixtures thereof (e.g., aerosols, emulsions, suspensions, and the like). Then, the integrated sensing probe 100 directs light onto the sample surface. The radiation interacts with the target compounds in the liquid disposed on the sample surface (e.g., with or without immobilized chemistry at the sample surface (e.g., a complementary DNA strand, a receptor, a complexing agent, and the like) and/or with or without recognition chemistry (e.g., a complementary DNA strand, a receptor, a complexing agent, and the like), and a measurable signal change can be detected using the detection system 154. The target compounds can be bound or immobilized on the surface and/or unbound but disposed on the surface of the sample support. A detector system 154 disposed adjacent to the sample 152, or integrated into the tip 100, detects the interaction of radiation with the target compounds. The detected interaction can be correlated to the identity and/or quantity of the target compound.

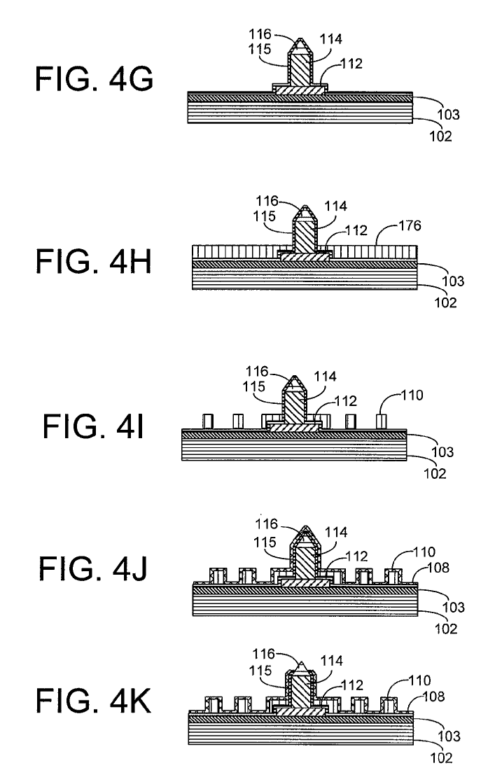

FIG. 3 illustrates an embodiment of a scanning integrated sensing probe 160 that includes an integrated sensing probe 100 and a micro-cantilever sample stage 162. The micro-cantilever sample stage 162 includes a sample plate 164 and a substrate 166, where the sample plate 164 and the substrate 166 are connected by a flexible bridge 168 that includes a and piezoresistor, or any other detection technology for sensing displacement of the micro-cantilever (e.g., optical detection, and the like). In general, the micro-cantilever sample stage includes a sample location, where the sample is placed, and one or multiple flexible bridges connecting the sample plate to a micro-cantilever sample stage substrate, such that any deformation of the micro-cantilever stage occurs at the flexible bridges in response to localized interaction of the sample surface with the coaxial waveguide tip. In other words, scanning integrated sensing probe 160 function like an AFM except that the tip and the cantilever are separate components. The piezoresistor senses the deflection of the cantilever of the sample stage between the sample and coaxial waveguide tip 116 so as to control the contact force and collect the sample profile data. The cantilever deflection can be measured by other measurement schemes such as, but not limited to, optical interferometry, magnetic force, electrostatic force, and capacitive sensing. The integrated sensing probe 100 is stationary while the micro-cantilever sample stage 162 can move in the x-, y-, and/or z-direction. The micro-cantilever sample stage 162 moves to position the integrated sensing probe 100 over a portion of the sample 164. The integrated sensing probe 100 can detect one or more targets or events by focusing the radiation onto the sample 164. In addition, the integrated sensing probe 100 can operate as a near-field scanning probe such as, but not limited to, an atomic force microscope (AFM), scanning tunneling microscope (STM), scanning electrochemical microscope (SECM), scanning thermal microscope (SThM), scanning Kelvin probe microscope, and the like. Embodiments of the integrated sensing probe 100 could be constructed to add supplementary components to the integrated sensing probe 100, which allows for the near-field scanning function. For example, by coating the coaxial waveguide tip with a metal film, which is selectively connected to an electrical data inquisition system, the coaxial waveguide tip can obtain electrical, magnetic, thermal, and/or electro-chemical information about the sample, as well as modify sample surface properties during intrinsic optical biosensing and surface profiling. Such an electrical inquisition can also be contacted to the efficient coupling structures side of the probe, as this structure is electrically contacted to the probing tip. By appropriate electromagnetic design, the efficient coupling structure can be contacted with a low frequency signal (e.g., with conductive lines in the same layer as the efficient coupling structure) if the contacts are thin and orthogonal to the polarization and incidence plane of the incoming electromagnetic radiation.

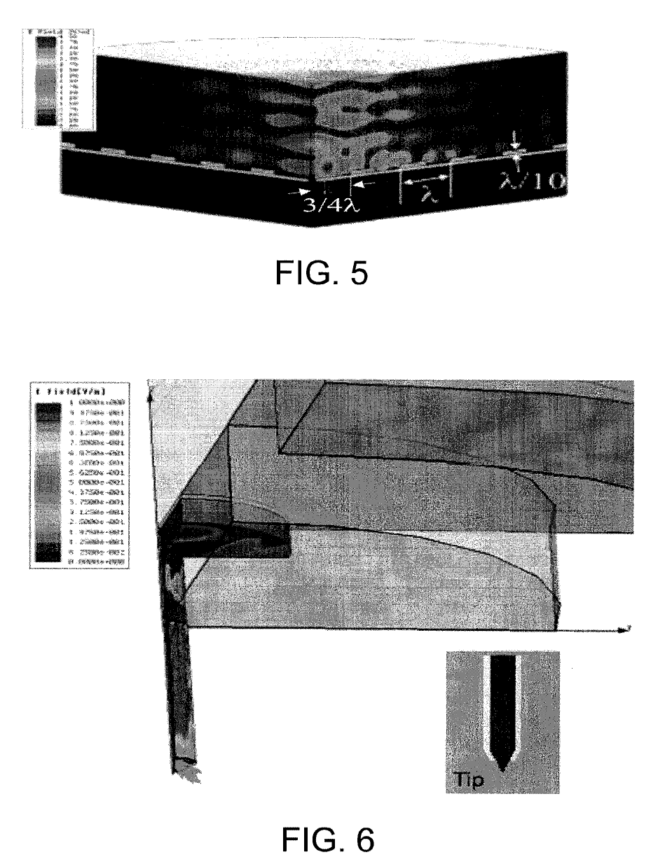

For the purposes of illustration only, and without limitation, embodiments of the present disclosure will be described with particular reference to the below-described fabrication methods. Note that not every step in the process is described with reference to the process illustrated in the figures hereinafter. Therefore, the following fabrication processes are not intended to be an exhaustive list that includes every step required to fabricate the embodiments of the illustrated components. In addition, the steps of the process can be performed in a different order to accomplish the same result. The materials and dimensions of many of the features discussed in reference to FIGS. 4A through 4K are discussed in detail herein.

FIGS. 4A through 4K illustrate an embodiment of a method of fabricating and embodiment of the integrated sensing probe shown in FIG. 1. FIG. 4A illustrates a substrate 102, a transparent separation layer 103, a highly conductive layer 103a, and a structure disposed thereon that will be the coaxial waveguide tip 116. The coaxial waveguide tip 116 can be fabricated using techniques such as, but not limited to, chemical wet etching, focused ion beam (FIB) milling, reactive ion etching (RIE), spin coating, photoablation, electric discharge machining (EDM), and the like.

FIG. 4B illustrates a mask 174 disposed on the coaxial waveguide tip 116. The mask 174 can be made of materials such as, but not limited to, metal, photosensitive polymer, nano-imprint resist, dielectric material, semiconductor, and the like. The mask 174 can be deposited using techniques such as, but not limited to, evaporation, sputtering, PECVD, LPCVD, ion beam assisted deposition, electron beam assisted deposition, spin coating, and the like.

FIG. 4C illustrates the formation of the inner core 114 having the coaxial waveguide tip 116 disposed at the top of the inner core 114. The inner core 114 can be fabricated using techniques such as, but not limited to, chemical wet etching, focused ion beam (FIB) milling, reactive ion etching (RIE), spin coating, electric discharge machining (EDM), photoablation, and the like.

FIG. 4D illustrates another portion of the mask 174 (alternatively a new mask can be used) disposed around the inner-core 114. The mask 174 can be made of the same material as described above and disposed using the same techniques.

FIG. 4E illustrates the removal of a portion of the highly conductive layer 103a to form an efficient coupling structure 112. The highly conductive layer 103a can be removed using techniques such as, but not limited to, chemical wet etching, focused ion beam (FIB) milling, reactive ion etching (RIE), electric discharge machining (EDM), photoablation, and the like. FIG. 4F illustrates the removal of the mask 174. The mask 174 can be removed using techniques such as, but not limited to, chemical wet etching, reactive ion etching (RIE), focused ion beam (FIB) milling, and the like.

FIG. 4G illustrates the formation of a dielectric layer 115 onto the coaxial waveguide tip 116, the inner core 114, the efficient coupling structure 112, and the separation layer 103. The dielectric layer 115 can be formed using techniques such as, but not limited to, thermal oxidation, plasma enhanced chemical vapor deposition (PECVD), low pressure chemical vapor deposition, room temperature polymer coating, atomic layer deposition (ALD), polymer spin coating, sputtering, evaporation, and the like.

FIG. 4H illustrates the formation of a layer of material 176. The material 176 corresponds to the same material as the corrugation support layer described herein. The material 176 can be disposed onto the dielectric layer 115 using techniques such as, but not limited to, thermal oxidation, plasma enhanced chemical vapor deposition (PECVD), low pressure chemical vapor deposition, room temperature polymer coating, atomic layer deposition (ALD), polymer spin coating, sputtering, evaporation, and the like.

FIG. 4I illustrates the formation of the corrugation support layer 110 using a masking technique or nano-printing technology. In another embodiment, nano-printing technology could be used to form and structure the corrugation support layer 110 in one fabrication step.

FIG. 4J illustrates the disposing a metal layer 108 onto the corrugation support layer 110 and the dielectric layer 115. The metal layer 108 can be disposed using techniques such as, but not limited to, evaporation, sputtering, and electroplating.

FIG. 4K illustrates the removal of a portion of the metal layer 108 and the dielectric layer 115 from the coaxial waveguide tip 116 to expose the coaxial waveguide tip 116. The metal layer 108 and the dielectric layer 115 can be removed simultaneously or sequentially using techniques such as, but not limited to, FIB milling, RIE, chemical wet etching, and the like.

While embodiments of the present disclosure are described in connection with Examples 1 and 2 and the corresponding text and figures, there is no intent to limit the disclosure to the embodiments in these descriptions. On the contrary, the intent is to cover all alternatives, modifications, and equivalents included within the spirit and scope of embodiments of the present disclosure.

### EXAMPLES

### Example 1

The dimensions of the integrated terahertz (THz) sensing probe are designed to: (i) maximize the coupling and concentration of incident THz radiation to a coaxial waveguide probe by using surface plasmon polaritions (SPP) on a corrugated reflective surface and a coaxial waveguide structure (a coaxial coupling structure), (ii) achieve a high probing resolution by integrating a sub-wavelength coaxial waveguide tip, and (iii) fabricating the integrated sensing probe using conventional microfabrication techniques. Another design parameter involves combining the integrated sensing probe with an external concave mirror to obtain higher sensitivity sensing that can be attained for resonant probing at the cavity resonance. In this case, the corrugated reflective surface functions as one cavity mirror.

The design of the integrated sensing probe includes a number of considerations, as discussed below. The period of the corrugated reflective surface is determined so as to couple incident radiation to SPP modes on the metal-dielectric interface and to focus the SPP waves to the central coaxial waveguide structure coupling region. The coupling of free-space radiation to a SPP mode occurs when the equation given below is satisfied:

kₛₚ=Kₒ+Nk_{g},

where kₛₚ is the surface plasmon polariton wave vector, kₒ is the portion of the incident wave vector that lies in the plane of the corrugation, k_{g}(=2π/λ_{g}) is the grating wave vector with Ag the grating period, and N any integer. The surface plasmon wave vector is given by:

$${k}_{sp} = {k}_{o} \sqrt{\frac{{ɛ}_{m} {ɛ}_{d}}{{ɛ}_{m} + {ɛ}_{d}}} ,$$

where ∈_{d} and ∈ₘ denote the permittivity of dielectric and metallic media, respectively. By choosing the proper distance between the coaxial waveguide and the first corrugation period, the SPP electric field is resonantly enhanced and the radiation transmitted through the coaxial waveguide tip (ultra-small aperture) is therefore maximized

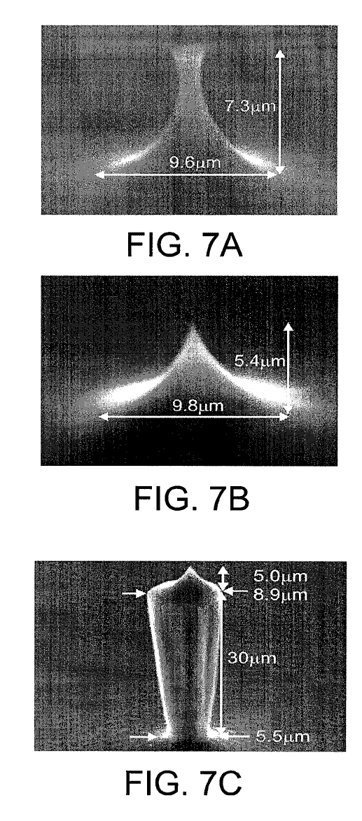

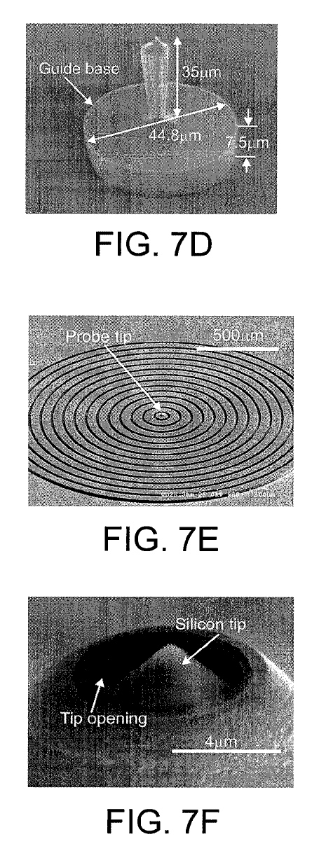

To analyze and optimize the coupling to the surface plasmon polariton mode and to the coaxial waveguide structure in order to maximize the field transmission through the coaxial waveguide tip, repeated simulations varying parameters of the coaxial waveguide structure have been made. The coupling strength of the free-space wave to a surface plasmon polariton mode scales with the corrugation height, which is chosen to be as large as technologically feasible to ensure maximal coupling efficiency. The coupling frequency is determined by the corrugation period, which corresponds to the wavelength of free-space radiation relating to the dielectric at the metallo-dielectric interface. A crucial dependency exists for the distance between the center and the first corrugation period as this distance decides on constructive or destructive interfere of surface plasmon polaritons from opposite parts of the corrugation. Simulations as varying this distance indicate that the electric field coupled to surface plasmon polaritons at THz frequencies becomes maximized near the center and directed towards the coaxial waveguide tip if the distance equals three quarters of the SPP wavelength (FIG. 5). The maximum electric field amplitude is then located at half a wavelength distance to the center. To enhance the coupling efficiency to the coaxial waveguide structure further, a capacitive disk-like coupling structure (efficient coupling structure) with a radius of half a wavelength is integrated to the coupling end of the coaxial waveguide tip's inner conductor. Exemplary dimensions of prototype coaxial waveguide structure for 0.5, 1.0 and 2.0 THz are listed in the Table 1 (also see FIG. 1C). The corrugation height is chosen to 20 μm as a compromise between manufacturability and coupling efficiency, which is more than the minimum value of λ/10 (in silicon) for any of the 0.5, 1.0, and 2.0 THz devices. The coaxial waveguide tip protrudes the center corrugation disk by 20 to 25 μm to ensure single contact of the tip apex to a sample surface without any additional contact at the far outer corrugated reflective surface considering the large chip size (2˜3 mm) in comparison to the tip height. The coaxial waveguide tip width is set to 10 μm to enable more easily a high probing resolution while maintaining a technologically feasible not too high aspect ratio for the tip. Several calculations according to standard coaxial theory have been performed to determine the expected transmission through the coaxial tip with respect to the dielectric material thickness. A 95% transmission efficiency is expected in case that the ratio of coaxial shield radius to coaxial core radius of the coaxial waveguide is 1.2 (FIG. 6). In this case, the dielectric layer (not shown in the figures for clarity) in the coaxial waveguide structure made out of silicon dioxide is set to 1 μm.

TABLE 1
Examplary dimensions of the microfabricated THz probe
for silicon substrate (n = 3.42) and SU-8 (n = 1.711)
corrugation support layer (also see FIG. 1C).

| Frequency (THz) | 0.5 | 1 | 2 |
|---|---|---|---|
| (a) Diameter of Tip hat (μm) | 87.7 | 43.8 | 21.9 |
| (b) Diameter of central structure (μm) | 263.0 | 131.5 | 65.7 |
| (c) Width groves (μm) | 87.7 | 43.8 | 21.9 |
| (d) Width corrugation (μm) | See Table 2 | | |
| (e) Height of tip hat (μm) | 5 | 5 | 5 |
| (f) Height of corrugation (μm) | 20 | 20 | 20 |
| (g) Tip length (μm) | 50 | 50 | 50 |
| (h) Distance tip hat to substrate (μm) | <=2 | <=2 | <=2 |
| (i) Diameter of post | 10 | 10 | 10 |
| (k) Open tip length (μm) | 1 | 1 | 1 |

Variation: Corrugation (d) (μm)

| | | | |
|---|---|---|---|
| f = 0.5 THz | 87.7 | 175.3 | 131.5 |
| f = 1.0 THz | 43.8 | 87.7 | 65.7 |
| f = 2.0 THz | 21.9 | 43.8 | 32.9 |

To address all possible situations, the corrugation width is varied to satisfy the cases that (i) the photoresist does not govern the incident wave (c=d=λ/3.42); (ii) the photoresist does govern the incident wave (d=λ/1.711); and (iii) the photoresist does govern the incident wave partially (d=λ(3.42⁻¹+1.711⁻¹)/2). This is done since the optimal ratio is not known at this time.

TABLE 2
Variation of the corrugation width (d).

| Frequency | b | c | d | b/2 | 3(c + d)/4 |
|---|---|---|---|---|---|
| 0.5 | 263 | 87.7 | 87.7 | 131.5 | 131.55 |
| | 263 | 87.7 | 131.5 | 131.5 | 164.4 |
| | 263 | 87.7 | 175.3 | 131.5 | 312.375 |
| 1 | 131.5 | 43.8 | 43.8 | 65.75 | 65.7 |
| | 131.5 | 43.8 | 65.7 | 65.75 | 82.125 |
| | 131.5 | 43.8 | 87.7 | 65.75 | 98.625 |
| 2 | 65.7 | 21.9 | 21.9 | 32.85 | 32.85 |
| | 65.7 | 21.9 | 32.9 | 32.85 | 41.1 |
| | 65.7 | 21.9 | 43.8 | 32.85 | 49.275 |

Calculation of the transmission efficiency through the untapered part of the coaxial waveguide tip is performed according to standard coaxial theory (cf. D. M. Pozar, “Microwave Engineering”, 3^{rd} edition, John Wiley & Sons, Inc.) for different ratios A of shield radius to core radius. The length of the transmission line is assumed to be 30 μm, which is the longest achievable length taking into account the dimensions of a 20 μm thick layer of photoresist as the corrugation support material and the substrate used for probe fabrication, which is a SOI wafer including a 50 μm thick highly conductive silicon, on a SiO₂ separation layer and a 500 μm high resistivity silicon substrate. Calculations for some values of A in the range from 2 down to 1.2 at frequencies 0.5, 1.0, and 2.0 THz yield a transmission efficiency from ˜98% down to ˜95%, respectively for all frequencies.

Simulation of the electrical field is performed using Ansoft's Hess software based on finite element method to solve Maxwell's equations. The structure is modeled according to the technologically fabricated device, taking dielectric properties of the different materials into account. For the coaxial waveguide core as well as the gold metal layer, the dielectric values from HFSS's material database is applied, thus reflecting approximated values for the material properties. However, Ohmic losses introduced by dielectric properties of gold and highly doped silicon at THz frequencies should not deteriorate the simulation results strongly. Dielectric properties of the photoresist are modeled for SU-8 at 1 THz and assumed constant over the range from 0.5 to 2.0 THz. Exciting field is a linear polarized Gaussian beam with beam waist w=750 μm located at the lower corrugation plane and electrical field amplitude E₀=1 Vm⁻¹. The simulation volume comprises above and below the whole device an air layer of several wavelengths to ensure correct convergence of the solver numeric solution.

### Example 2

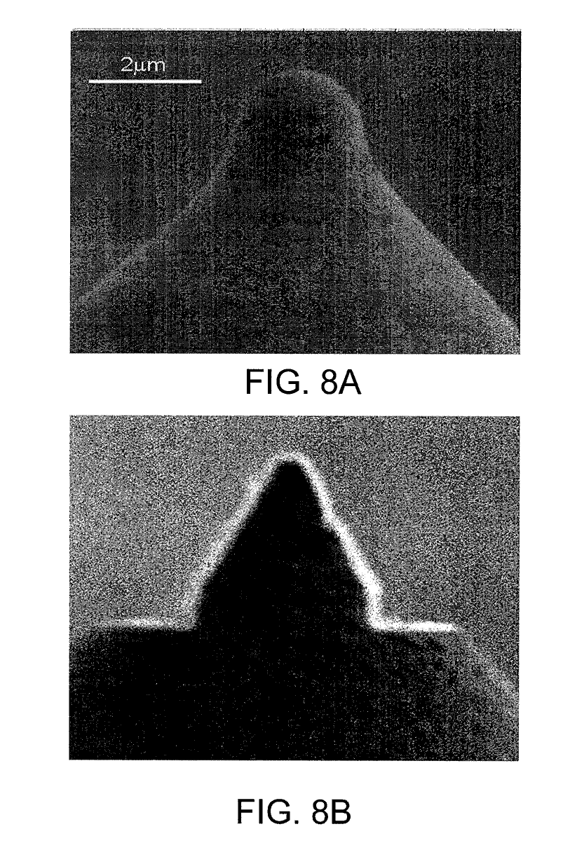

FIGS. 7A through 7F show SEM pictures of fabrication steps of the coaxial waveguide tip. FIG. 7A illustrates a dry-etched conical silicon tip, FIG. 7B illustrates a sharpened tip using thermal oxidation and successive wet etching, FIG. 7C illustrates an inner core and the wave guide tip, FIG. 7D illustrates an efficient coupling structure, FIG. 7E illustrates a corrugated reflective surface, and FIG. 7F illustrates a sharp probe tip with ring aperture.

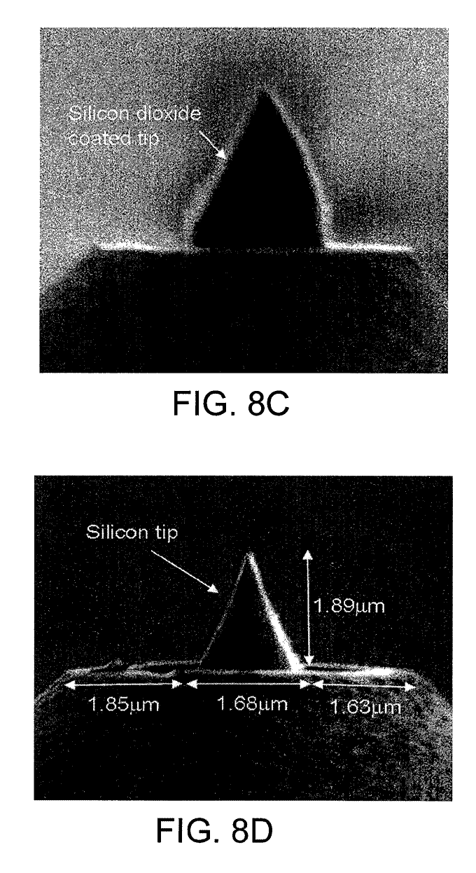

FIG. 8A through 8D show sub-wavelength aperture and tip fabrication schemes using FIB milling and wet etching. FIG. 8A illustrates a silicon dioxide/gold coated silicon tip, FIG. 8B illustrates a FIB milling on one side of the tip, FIG. 8C illustrates a second FIB milling after 90° tip rotation along the axis of the tip, and FIG. 8D illustrates an exposed silicon tip after silicon dioxide wet etching.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. The term “about” can include ±1%, ±2%, ±3%, ±4%, ±5%, ±6%, ±7%, ±8%, ±9%, or ±10%, or more of the numerical value(s) being modified. In addition, the phrase “about ‘x’ to ‘y’” includes “about ‘x’ to about ‘y’”.

Although the methodologies of this disclosure have been particularly described in the foregoing disclosure, it is to be understood that such descriptions have been provided for purposes of illustration only, and that other variations both in form and in detail can be made thereupon by those skilled in the art without departing from the spirit and scope of the present invention, which is defined solely by the appended claims.

What is claimed is:

1. An integrated sensing probe, comprising:
a substrate, a corrugated reflective surface, and a coaxial waveguide structure, wherein the corrugated reflective surface and the coaxial waveguide structure are disposed on the substrate, wherein the coaxial waveguide structure is positioned at the center of the corrugated reflective surface.

2. The integrated sensing probe of claim 1, wherein the coaxial waveguide structure includes an efficient coupling structure, an inner core, a dielectric layer, and a coaxial waveguide tip, wherein the inner core is disposed on top of the efficient coupling structure, wherein the coaxial waveguide tip is disposed on top of the inner core, and wherein the dielectric layer is disposed on the sides of the inner core.

3. The integrated sensing probe of claim 2, wherein a reflective layer is disposed on the dielectric layer.

4. The integrated sensing probe of claim 3, wherein the coaxial waveguide tip includes a portion of the inner core that is covered by the dielectric layer and the dielectric layer is covered by the reflective layer, wherein the reflective layer is not in direct contact with the inner core.

5. The integrated sensing probe of claim 2, wherein the efficient coupling structure, the coaxial waveguide, and the coaxial waveguide tip are made of the same material.

6. The integrated sensing probe of claim 2, wherein the efficient coupling structure, the coaxial waveguide, and the coaxial waveguide tip are made of the different materials.

7. The integrated sensing probe of claim 2, wherein the efficient coupling structure, the coaxial waveguide, and the coaxial waveguide tip are made of a material that reflects and conducts radiation selected from: terahertz radiation of about 3 mm to 30 μm, mid-infrared radiation of about 30 μm to 3 μm, near-infrared radiation of about 3 μm to 800 nm, optical/visible radiation at about 800 nm to 400 nm, UV radiation at about 400 nm to 1 nm, about 1 nm to 0.01 nm, about 100.000 km to 1 mm, and combinations thereof.

8. The integrated sensing probe of claim 2, wherein the coaxial waveguide has a diameter of about 200 nm to 30 μm.

9. The integrated sensing probe of claim 2, wherein the coaxial waveguide tip has a length of about 1 to 100 μm.

10. The integrated sensing probe of claim 2, wherein the coaxial waveguide tip has a diameter of about 10 nm to 30 μm.

11. The integrated sensing probe of claim 2, wherein the coaxial waveguide structure has a height of about 100 nm to 80 μm above the corrugated reflective surface.

12. The integrated sensing probe of claim 1, wherein the corrugated reflective surface includes a plurality of ridges concentric around the coaxial waveguide structure, wherein each ridge has a center at the position of the coaxial waveguide structure.

13. The integrated sensing probe of claim 12, wherein the each of the ridges has the same height.

14. The integrated sensing probe of claim 12, wherein the corrugated reflective surface includes 2 to 5000 ridges.

15. The integrated sensing probe of claim 1, wherein the corrugated reflective surface includes a reflective layer that is about 0.15 to 12.6 μm thick.

16. The integrated sensing probe of claim 1, wherein the corrugated reflective surface includes a reflective layer that is a metal layer.

17. The integrated sensing probe of claim 16, wherein the metal layer is made of a metal selected from gold, silver, copper, platinum, aluminum, and combinations thereof.

18. The integrated sensing probe of claim 16, wherein the metal layer is gold.

19. The integrated sensing probe of claim 1, wherein the corrugated reflective surface includes a reflective layer that is a highly doped semiconductor layer.

20. The integrated sensing probe of claim 19, wherein the highly doped semiconductor layer is selected from: silicon, polysilicon, GaAs, Ge, SiGe, InP, InGaAs, GaN, metallic silicides, and combinations thereof.

21. The integrated sensing probe of claim 1, wherein the substrate is made of a material that is transparent to radiation selected from: terahertz radiation of about 3 mm to 30 μm, mid-infrared radiation of about 30 μm to 3 μm, near-infrared radiation of about 3 μm to 800 nm, optical/visible radiation at about 800 nm to 400 nm, UV radiation at about 400 nm to 1 nm, about 1 nm to 0.01 nm, about 100.000 km to 1 mm, and combinations thereof.

22. The integrated sensing probe of claim 1, wherein the corrugated reflective surface is a circular corrugated reflective surface.

23. A sensing system comprising:
an irradiation source;
an integrated sensing probe disposed adjacent the irradiation source, wherein the integrated sensing probe includes a substrate, a corrugated reflective surface, and a coaxial waveguide structure, wherein the corrugated reflective surface and the coaxial waveguide structure are disposed on the substrate, wherein the coaxial waveguide structure is positioned at the center of the corrugated reflective surface; and
a detection system adjacent the integrated sensing probe.

24. The sensing system of claim 23, wherein the coaxial waveguide structure includes an efficient coupling structure, an inner core, a dielectric layer, and a coaxial waveguide tip, wherein the inner core is disposed on the efficient coupling structure, wherein the coaxial waveguide tip is disposed on the inner core, and wherein the dielectric layer is disposed on the sides of the inner core.

25. The sensing system of claim 23, wherein a reflective layer is disposed on the dielectric layer.

26. The sensing system of claim 25, wherein the coaxial waveguide tip includes a portion of the inner core that is covered by the dielectric layer and the dielectric layer is covered by the reflective layer, wherein the reflective layer is not in direct contact with the inner core.

27. The sensing system of claim 23, wherein the corrugated reflective surface includes a plurality of ridges concentric around the coaxial waveguide structure, wherein each ridge has a center at the position of the coaxial waveguide structure.

28. The sensing system of claim 23, wherein the irradiation source includes a source selected from: terahertz radiation sources, mid-infrared radiation sources, near-infrared radiation sources, optical/visible radiation sources, UV radiation sources, X-ray sources, gamma-radiation sources, and radio-wave sources.

29. A method of detecting a target compound, comprising:
providing a substrate having the target compound disposed thereon;
placing an integrated sensing probe disposed adjacent the irradiation source, wherein the integrated sensing probe includes a substrate, a corrugated reflective surface, and a coaxial waveguide structure, wherein the corrugated reflective surface and the coaxial waveguide structure are disposed on the substrate, wherein the coaxial waveguide structure is positioned at the center of the corrugated reflective surface;
irradiating a position on the substrate with radiation from the coaxial waveguide structure; and
measuring a signal resulting from the interaction of the target compound and the radiation.

30. An integrated sensing and scanning probe system comprising:
an integrated sensing probe that includes a substrate, a corrugated reflective surface, and a coaxial waveguide structure, wherein the corrugated reflective surface and the coaxial waveguide structure are disposed on the substrate, wherein the coaxial waveguide structure is positioned at the center of the corrugated reflective surface.

31. The integrated sensing and scanning probe system of claim 30, wherein the integrated sensing and scanning probe system is adapted to operate as a scanning probe selected from: an atomic force microscope (AFM), a scanning tunneling microscope (STM), a scanning electrochemical microscope (SECM), a scanning thermal microscope (SThM), and a scanning Kelvin probe microscope.

32. An integrated sensing probe, comprising:
a substrate, a corrugated reflective surface, and a coaxial waveguide structure, wherein the corrugated reflective surface and the coaxial waveguide structure are disposed on the substrate, wherein the coaxial waveguide structure is positioned at the center of the corrugated reflective surface;
wherein the corrugated reflective surface includes a plurality of ridges concentric around the coaxial waveguide structure, wherein each ridge has a center at the position of the coaxial waveguide structure, wherein the corrugated reflective surface includes a reflective layer disposed on an area from the coaxial waveguide structure to the outer most ridge of the corrugated reflective surface; and
wherein the coaxial waveguide structure includes an efficient coupling structure, an inner core, a dielectric layer, and a coaxial waveguide tip, wherein the inner core is disposed on the efficient coupling structure, wherein the coaxial waveguide tip is disposed on the inner core, and wherein the dielectric layer is disposed on the sides of the inner core, wherein the coaxial waveguide tip includes a first portion of the inner core that is covered by the dielectric layer and the dielectric layer is covered by the reflective layer, wherein the coaxial waveguide tip includes a second portion of the inner core that is not covered by the dielectric layer and the dielectric layer is covered by the reflective layer, and wherein the reflective layer is not in direct contact with the inner core.
